(19) United States
(12) Patent Application Publication
(10) Pub. No.: US 2007/0208739 A1
(43) Pub. Date: Sep. 6, 2007

(54) SYSTEM AND METHOD FOR EVALUATING PATENTS

(75) Inventors: CHUNG-I LEE, Tu-Cheng (TW); HAI-HONG LIN, Shenzhen (CN); DE-YI XIE, Shenzhen (CN); CHEN-CHEN ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/558,470

(22) Filed: Nov. 10, 2006

(30) Foreign Application Priority Data
Mar. 3, 2006 (CN) 200610034174.5

(51) Int. Cl. G06F 17/30

(52) U.S. Cl. 707/6; 707/7; 707/10

(57) ABSTRACT

A computer-based method for evaluating patents is provided. The method includes the steps of: obtaining patents to be evaluated from a database server according to a predetermined patents evaluating date; assigning one or more undertakers to evaluate the patents; gathering basic information of the patents from the database server; providing the undertakers with evaluation parameters of each patent according to the basic information of the patents; submitting evaluation opinions made by the undertakers to relevant patents owners; and receiving evaluation decisions made by the patents owners and sending the evaluation decisions to the undertakers. A related system is also disclosed.

### BACKGROUND OF THE INVENTION

1. Field of the Invention

The present invention is related to a system and a method for evaluating patents.

2. General Background

Intellectual Property (often referred to as “IP”) plays a key role in corporations and can be very valuable. Modern market trends, especially those of the past two decades, have shown an increased awareness and understanding of a need for determining a value of intangible assets in general and of intellectual property assets in particular.

The necessity to evaluate a patent manifests itself many times during the patent's life, even before an application for the patent is filed. Initially, a decision must be made whether to file a patent application or to keep an invention a trade secret. It may be advantageous to repeat the evaluation one or more times during the prosecution of the patent application to reflect the changing probabilities of issuance of the desired patent, particularly before the patent application is published. The evaluation may be repeated again before patent issue fee is paid, and yet again before each payment of annual fee.

In the past, the evaluation is done manually, which was an onerous, expensive, and time consuming work. Patents that to be evaluated need to be sought out from a large patent collection manually; and during the evaluation, interrelated information parameters with the patents may not be provided, validity and integrity of the evaluation need to be verified manually.

What is needed, therefore, is a system and a method for evaluating patents. The system and method can obtain the patents to be evaluated automatically from large portfolios of patents, and gather basic information of the patents for providing evaluation parameters when evaluating the patents, thus decreasing time, and improving efficiency.

### SUMMARY OF THE INVENTION

A system for evaluating patents is provided. The system includes a database server, and an application server. The application server includes: a patent obtaining module for obtaining patents to be evaluated from the database server; a distributing module for assigning one or more undertakers to evaluate the patents; a data gathering module for gathering basic information of the patents from the database server; a parameter prompting module for providing the undertakers with evaluation parameters of each patent according to the basic information of the patents; an opinion submitting module for submitting evaluation opinions made by the undertakers to relevant patents owners; and a result receiving module for receiving evaluation decisions made by the patents owners and sending the evaluation decisions to the undertakers.

Another preferred embodiment provides a computer-based method for evaluating patents. The method includes the steps of: obtaining patents to be evaluated from a database server according to a predetermined patents evaluating date; assigning one or more undertakers to evaluate the patents; gathering basic information of the patents from the database server; providing the undertakers with evaluation parameters of each patent according to the basic information of the patents; submitting evaluation opinions made by the undertakers to relevant patents owners; and receiving evaluation decisions made by the patents owners and sending the evaluation decisions to the undertakers.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of hardware configuration of a system for evaluating patents in accordance with a preferred embodiment;

FIG. 2 is a schematic diagram of function modules of an application server in FIG. 1; and

FIG. 3 is a flowchart illustrating a method for evaluating patents in accordance with a preferred embodiment.

### DETAILED DESCRIPTION OF THE INVENTION

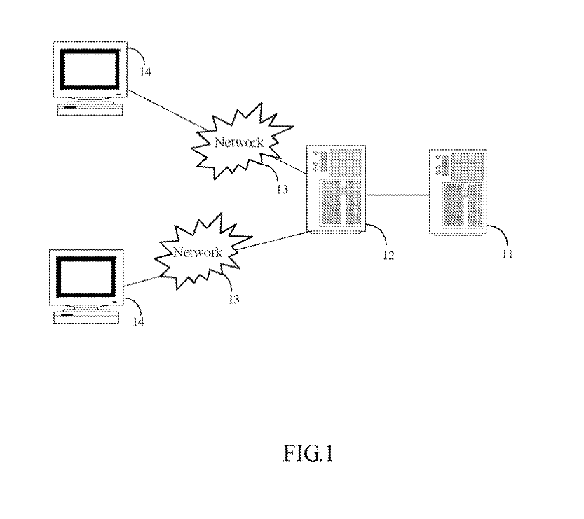

FIG. 1 is a schematic diagram of hardware configuration of a system for evaluating patents (hereinafter “the system”), in accordance with a preferred embodiment. The system typically includes a database server 11, an application server 12, a network 13, and a plurality of distributed client computers 14 (only two shown). The client computers 14 electronically connect to the application server 12 via the network 13. The network 13 is an electronic network, which may be the Internet, an Intranet, or any other suitable type of network. The application server 12 connects to the database server 11 through a connection. The connection may be an Open Database Connectivity (ODBC), a Java Database Connectivity (JDBC), or any others.

The database server 11 includes a database which stores large portfolios of patents and basic information of the patents. The application server 12 includes a plurality of function modules, which are mainly configured for automatically obtaining patents to be evaluated and gathering basic information of the patents from the database server 11, assigning one or more undertakers to evaluate the patents, and providing evaluation parameters when the undertakers evaluate the patents. The client computers 14 may be distributed at different locations in different parts of the world; each of the client computers 14 provides a graphical user interface (GUI) for the undertakers to conveniently examine the patents and the basic information of the patents.

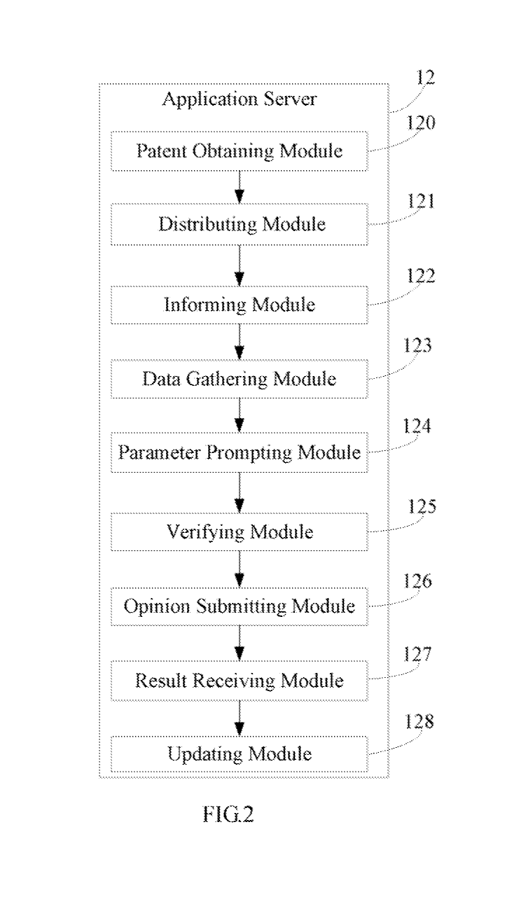

FIG. 2 is a schematic diagram of function modules of the application server 12. The application server 12 mainly includes a patent obtaining module 120, a distributing module 121, an informing module 122, a data gathering module 123, a parameter prompting module 124, a verifying module 125, an opinion submitting module 126, a result receiving module 127, and an updating module 128.

The patent obtaining module 120 is configured for obtaining patents to be evaluated automatically from the database server 11. The distributing module 121 is configured for assigning one or more undertakers to evaluate each of the patents. Usually, if the patent has been previously evaluated, the patent may be distributed to the undertaker who previously evaluated it.

The informing module 122 is configured for informing the undertakers to evaluate the patents by sending emails or any other contacting means, so that the undertakers can evaluate the patents in a timely manner. The data gathering module 123 is configured for gathering the basic information of the patents from the database server 11.

The parameter prompting module 124 is configured for providing undertakers with evaluation parameters of each patent according to the basic information of the patents. The evaluation parameters of each patent may include: whether the patent or any member in the patent family has ever been licensed to any corporations; whether any patent in the patent family has been invalidated; whether the patent infringement analysis has ever been made on relevant products of the patent; the development of the patent family, and so on. With the evaluation parameters the undertaker can better estimate, such as, stability and usability of the patent.

The verifying module 125 is configured for verifying the integrity and the validity of the evaluation made by the undertakers. For example, verifying whether the stability or the usability of the patents has been evaluated, and verifying whether the evaluation on the stability or the usability is valid.

The opinion submitting module 126 is configured for submitting evaluation opinions made by the undertakers to one or more owners of the patents. The evaluation opinions may be, for example, that the patents are in a stable condition, or in an unstable condition, and so on.

The result receiving module 127 is configured for receiving evaluation decisions made by the patents owners, such as, maintaining some of the patents or abandoning some of the patents, and also configured for sending the evaluation decisions to the undertakers.

The updating module 128 is configured for updating the basic information of the patents, such as, updating the status of the patents as maintained or abandoned in the database server 11 after the patents have been evaluated.

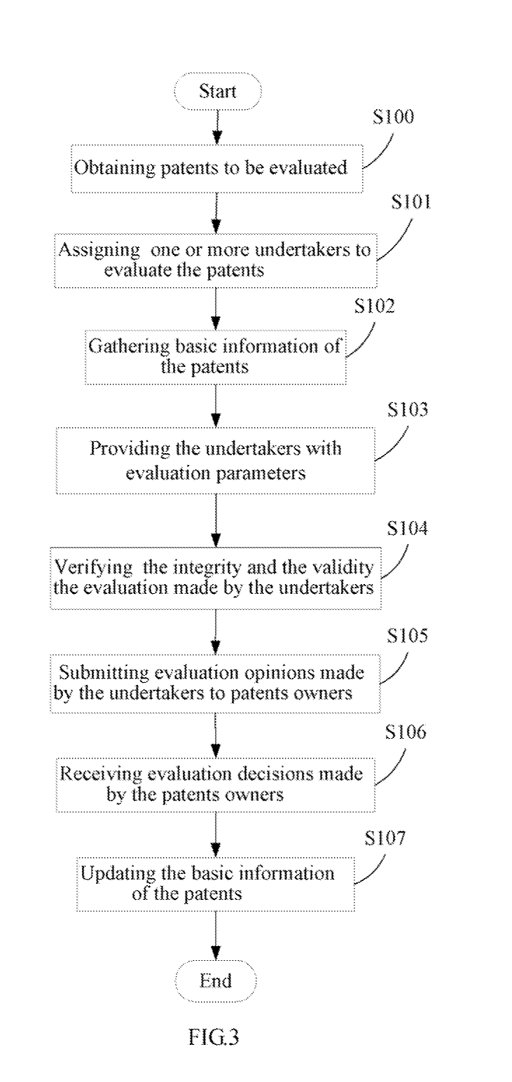

FIG. 3 is a flowchart illustrating a method for evaluating patents in accordance with a preferred embodiment. In step S100, the patent obtaining module 120 obtains one or more patents to be evaluated automatically from the database server 11. The patents to be evaluated may be obtained according to a predetermined date. The predetermined date may be one month before an expiration of each annual fee payment. For example, if Feb. 1, 2006 is the expiration of the annual fee payment of the patent fixed by the United States Patent and Trademark Office (USPTO), the patent obtaining module 120 may obtain the patent on Jan. 1, 2006. Furthermore, if the patent is a member of a patent family, the patent obtaining module 120 may also obtain the patent family members of the patent. The patent family of the patent conventionally refers to a group of patents filed at different national patent offices and/or international patent organizations, and the patents have identical or similar techniques and have a same legal priority.

In step S101, the distributing module 121 assigns one or more undertakers to evaluate each of the patents, and the informing module 122 informs the undertakers to evaluate the patents by sending emails or any other contacting means. Usually, if the patent has been previously evaluated, the patent may be distributed to the undertaker who previously evaluated it.

In step S102, the data gathering module 123 gathers basic information of the patents from the database server 11.

In step S103, The parameter prompting module 124 provides the undertakers with evaluation parameters of each patent according to the basic information of the patents. The evaluation parameters of each patent may include: whether the patent or any member in the patent family has ever been licensed to any corporations; whether any patent in the patent family has been invalidated; whether the patent infringement analysis has ever been made on relevant products of the patent; the development of the patent family, and so on. With the evaluation parameters the undertakers can estimate, such as, stability and usability of the patents. For example, according to whether any patent in the patent family has been invalidated, the undertaker can estimate the stability of the patent is either good, or common, or bad; according to whether the patent infringement analysis has ever been made on relevant products of the patent, the undertaker can estimate the usability of the patent is either good, or common, or bad, and so on.

In step S104, the verifying module 125 verifies the integrity and the validity of the evaluation made by the undertakers. For example, verifying whether the stability or the usability of the patents has been evaluated, and verifying whether the evaluation for the stability or the usability is valid.

In step S105, The opinion submitting module 126 submits evaluation opinions made by the undertakers to one or more owners of the patents The evaluation opinions may be, for example, that the patents are in a stable condition, or in an unstable condition, and so on.

In step S106, The result receiving module 127 receives the evaluation decisions made by the patent owners, such as, maintaining some of the patents or abandoning some of the patents, and sends the evaluation decisions to the undertakers.

In step S107, The updating module 128 updates the basic information of the patents, such as, updating the status of the patents as maintained or abandoned, in the database server 11 after the patents are evaluated.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for evaluating patents comprising a database server and an application server, the application server comprising:
a patent obtaining module for obtaining patents to be evaluated from the database server;
a distributing module for assigning one or more undertakers to evaluate the patents;
a data gathering module for gathering basic information of the patents from the database server;
a parameter prompting module for providing the undertakers with evaluation parameters of each patent according to the basic information of the patents;
an opinion submitting module for submitting evaluation opinions made by the undertakers to patents owners; and
a result receiving module for receiving evaluation decisions made by the patents owners and sending the evaluation decisions to the undertakers.

2. The system according to claim 1, wherein the evaluation parameters of each patent comprise: whether the patent or any member in the patent family has ever been licensed to any corporations; whether any patent in the patent family has been invalidated; whether the patent infringement analysis has ever been made on relevant products of the patent; and the development of the patent family.

3. The system according to claim 1, wherein the application server further comprises an informing module for informing the undertakers to evaluate the patents.

4. The system according to claim 1, wherein the application server further comprises a verifying module for verifying the integrity and the validity of the evaluation made by the undertakers.

5. The system according to claim 1, wherein the application server further comprises an updating module for updating the basic information of the patents in the database server after the patents have been evaluated.

6. A computer-based method for evaluating patents, the method comprising the steps of:
obtaining patents to be evaluated from a database server according to a predetermined patents evaluating date;
assigning one or more undertakers to evaluate the patents;
gathering basic information of the patents from the database server;
providing the undertakers with evaluation parameters of each patent according to the basic information of the patents;
submitting evaluation opinions made by the undertakers to patents owners; and
receiving evaluation decisions made by the patents owners and sending the evaluation decisions to the undertakers.

7. The method according to claim 6, wherein the evaluation parameters of each patent comprise: whether the patent or any member in the patent family has ever been licensed to any corporations; whether any patent in the patent family has been invalidated; whether the patent infringement analysis has ever been made on relevant products of the patent; and the development of the patent family.

8. The method according to claim 6, further comprising the step of: informing the undertakers to evaluate the patents.

9. The method according to claim 6, further comprising the step of:
verifying the integrity and the validity of the evaluation made by the undertakers.

10. The method according to claim 6, further comprising the step of:
updating the basic information of the patents in the database server after the patents have been evaluated.
